(19) United States
(12) Patent Application Publication
(10) Pub. No.: US 2021/0153511 A1
(43) Pub. Date: May 27, 2021

(54) METHOD AND PRODUCT FOR IMPARTING THE TEXTURE OF FRESH FOODS TO FROZEN FOODS

(71) Applicant: Alaaeldin Soliman, Holmdel, NJ (US)

(72) Inventor: Alaaeldin Soliman, Holmdel, NJ (US)

(21) Appl. No.: 16/693,278

(22) Filed: Nov. 23, 2019

(51) Int. Cl. A21D 17/00; A21D 15/02; A21D 8/02; A21D 2/36; A21D 2/26

(52) U.S. Cl. CPC A21D 17/004; A21D 15/02; A21D 2/262; A21D 2/362; A21D 8/02

(57) ABSTRACT

A method of preparing a food item from a frozen dough includes thawing the frozen dough, mechanically agitating the thawed dough, forming the thawed dough into cooking portions, and cooking the cooking portions to obtain the food item. The method may also include the step of providing frozen flavoring ingredients, thawing the flavoring ingredients, and mixing the flavoring ingredients with the thawed dough during the mechanical agitation step. A product is provided that includes the frozen dough and the flavoring ingredients, the product being adapted to keep the frozen dough separate from the flavoring ingredients. Methods of making the product are also provided.

### BACKGROUND

### Technical Field

The embodiments herein generally relate to food preparation, and more particularly to methods and products for imparting at least the texture of fresh foods to frozen foods.

### Description of the Related Art

Falafel is a popular food of middle-eastern origin. It is made from certain beans blended with onion, garlic, green leaves, and herbs. This mix results in a dough that will be shaped into discs or balls and deep fried in oil.

Currently, there are two ways of making falafel in common use. First, the falafel can be made from scratch by mixing all the ingredients and blending them into the falafel dough and then immediately frying predetermined quantities or cooking portions of the falafel dough that are shaped into the discs or balls described previously. Second, the falafel can be made from pre-made frozen packages of falafel dough, which are formed into cooking portions as described, if they are not already so formed, and fried after defrosting.

There is a marked difference in texture, and in turn palatability, between falafel made from freshly made and blended falafel dough and falafel made from frozen falafel dough. Most consumers and gourmets favor the falafel made from fresh dough because it is fluffy and airy and it has much better consistency as compared to falafel made from the frozen falafel dough, which is compressed and heavy and is often not well cooked in the center if burning of the exterior portions are to be avoided. However, freezing the falafel dough may still be desirable for longer term preservation of the dough, for example, for storage or transportation. Accordingly, there is a need for methods and products that provide the benefits of freezing the dough while providing a texture and quality in the cooked falafel that more closely approaches the texture and quality of falafel freshly made from scratch.

### SUMMARY

In view of the foregoing, methods and products for preparing a food item from frozen dough are provided by the embodiments disclosed herein that allow the benefits of freezing to be realized while providing a food item having a quality more closely approaching the quality of the same food item had it been made from fresh ingredients. In one embodiment, the method comprises thawing the frozen dough to provide a thawed dough; mechanically agitating the thawed dough; forming at least one cooking portion of a precursor for the food item, the precursor including at least an amount of the thawed dough; and cooking the cooking portion of the precursor to obtain the food item. The precursor of the food item is the dough after the step of mechanically agitating has been completed and that is ready to be cooked to obtain the food item, which in some examples herein is falafel. The frozen dough may be the first component of a frozen food product for preparing the food item.

In some examples, the method further comprises providing a second component that includes at least one additional ingredient. The step of providing a second component is followed by mixing the at least one additional ingredient with the thawed dough such that the at least one additional ingredient is evenly distributed throughout the thawed dough as a result of the step of mechanically agitating the thawed dough and the precursor comprises at least the thawed dough and the at least one additional ingredient.

In some embodiments herein, the frozen dough comprises at least one legume. In some embodiments herein, the second component comprises one or more ingredients selected from the group consisting of onion, garlic, and at least one herb. In some examples, the at least one legume is chickpeas, and the at least one herb comprises one or more herbs selected from the group consisting of parsley and cilantro.

Some embodiment herein are directed to methods for preparing a frozen product for preparation of a food item. In one example the food item may be falafel. In some embodiments herein, the method for preparing the frozen product comprises: preparing a dough; preparing at least one additional ingredient; freezing the dough to produce a frozen dough; freezing the at least one additional ingredient to produce at least one frozen additional ingredient; and packaging the frozen dough and the at least one frozen additional ingredient, which forms at least a part of the second component of the frozen product, such that the at least one frozen additional ingredient and the frozen dough remain isolated from each other while frozen prior to the initiation of steps to prepare the food item from the frozen dough and the at least one frozen additional ingredient.

Some embodiment herein are directed to a product comprising a dough comprising at least one legume; at least one additional ingredient comprising one or more ingredients selected from the group consisting of onion, garlic, and at least one herb; and packaging containing the dough and the at least one additional ingredient, the packaging being adapted such that the at least one additional ingredient and the dough remain isolated from each other prior to the initiation of steps to prepare the food item from the dough and the at least one additional ingredient.

These and other aspects of the embodiments herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a schematic diagram showing falafel dough formed into balls, according to an example;

FIG. 2 is a schematic diagram showing falafel dough formed into patties, according to an example;

FIG. 3 is a flow diagram of a method for preparing a food item from frozen dough according to some of the embodiments herein;

FIG. 4 is a flow diagram of a method for preparing a frozen product for preparation of a food item according to some of the embodiments herein;

FIG. 5 is a flow diagram of a first sequence of steps for preparing a dough in a method for preparing a frozen product for preparation of a food item according to some of the embodiments herein;

FIG. 6 is a flow diagram of a second sequence of steps for preparing a dough in a method for preparing a frozen product for preparation of a food item according to some of the embodiments herein;

FIG. 7 is a flow diagram of a third sequence of steps for preparing a dough in a method for preparing a frozen product for preparation of a food item according to some of the embodiments herein;

FIG. 8 is a schematic diagram illustrating a first embodiment of the packaging for a frozen product for preparation of a food item according to some of the embodiments herein;

FIG. 9 is a schematic diagram illustrating a second embodiment of the packaging for a frozen product for preparation of a food item according to some of the embodiments herein;

FIG. 10 is a schematic diagram illustrating a third embodiment of the packaging for a frozen product for preparation of a food item according to some of the embodiments herein;

FIG. 11 is a flow diagram of a method for preparing a food item from frozen dough according to some of the embodiments herein that use egg whites;

FIG. 12 is a flow diagram of a method for preparing a frozen product for preparation of a food item according to some of the embodiments herein that use egg whites; and

FIG. 13 is a schematic diagram illustrating a fourth embodiment of the packaging for a frozen product for preparation of a food item according to some of the embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

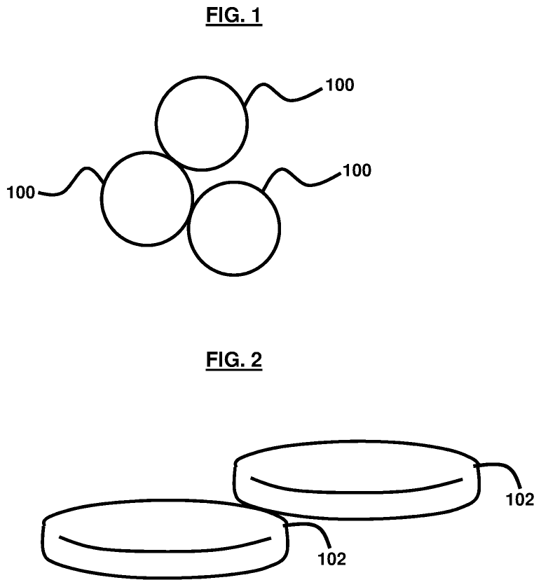

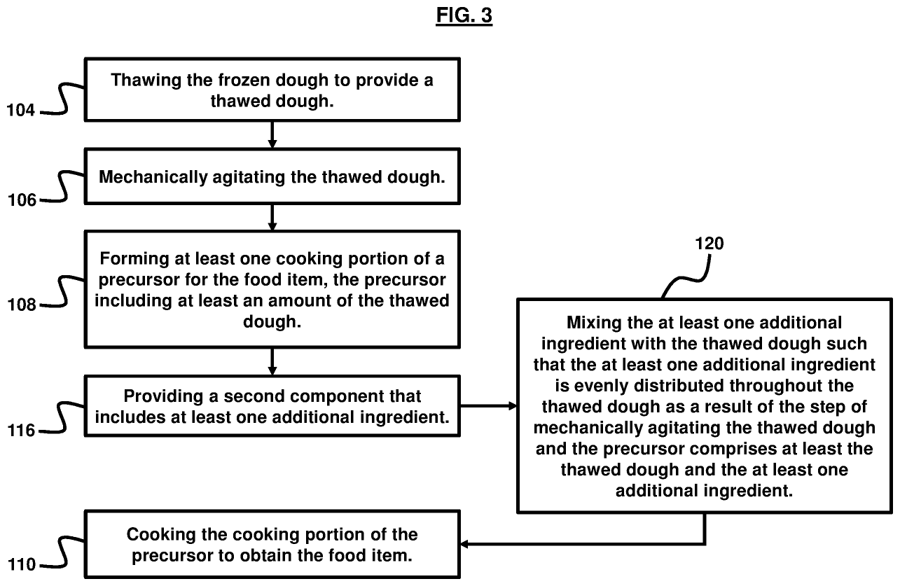

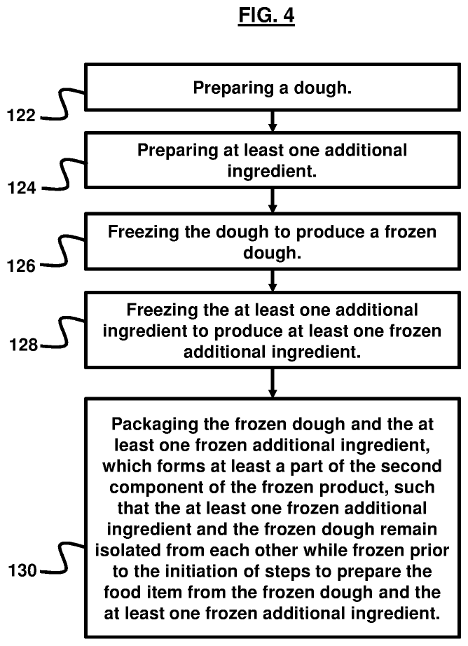

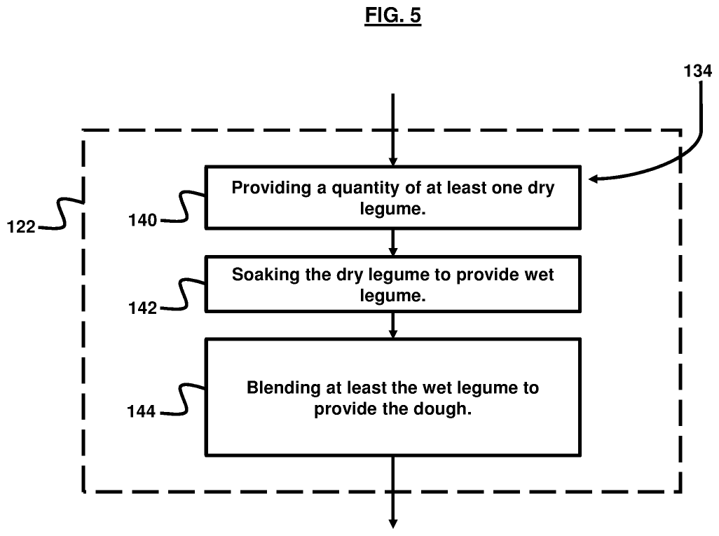

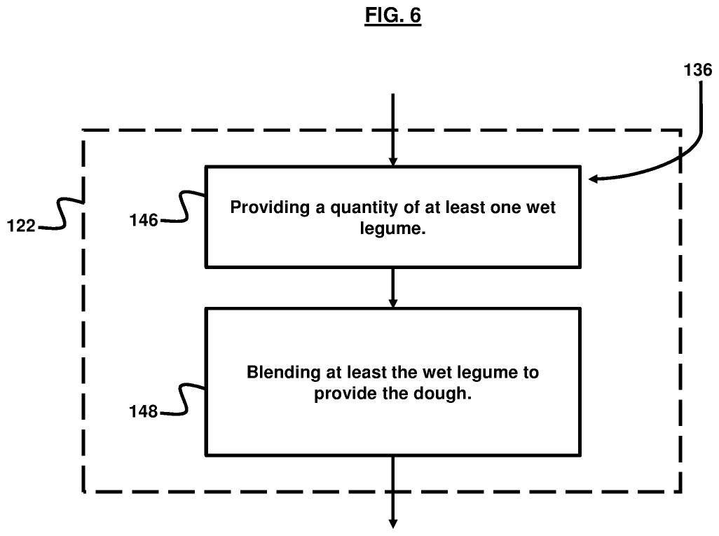

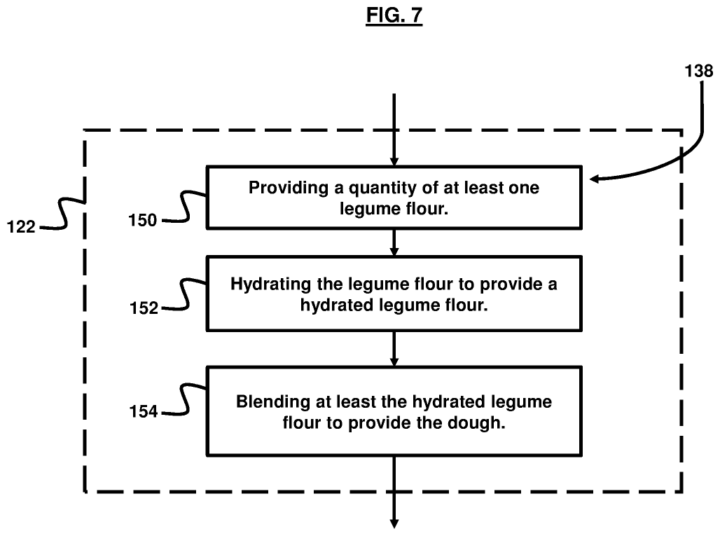

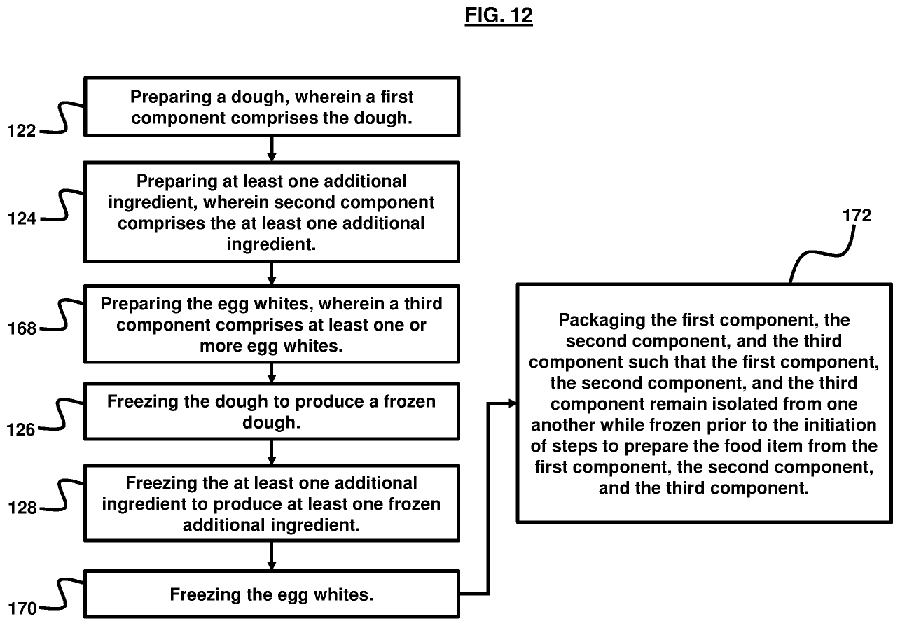

The embodiments herein are particularly suited for making foods having at least a fresh-made texture from frozen dough. Referring now to the drawings, and more particularly to FIGS. 1 through 13, where similar reference characters denote corresponding features consistently throughout the figures, there are shown preferred embodiments. In the drawings, the size and relative sizes of components, layers, and regions, etc. may be exaggerated for clarity.

Heretofore, falafel has been prepared either from completed fresh-made dough or from frozen completed dough. Most falafel recipes call for a dough, which is then shaped into cooking portions that are then deep fried. The cooking portions usually weigh on the order of one or a few ounces and are commonly shaped into balls 100 or patties 102 (see FIGS. 1 and 2). The dough made according to the typical recipes usually includes a blended bean base dough combined with other ingredients that include flavoring or flavor ingredients. By “completed dough” it is meant that the dough includes both the blended beans, which form at least in part the blended bean base dough, and the flavoring ingredients called for by the recipe.

Falafel made from fresh dough is fluffy and airy and it has much better consistency as compared to falafel made from frozen falafel dough, which is compressed and heavy and is often not well cooked in the center. While the embodiments herein are not intended to be limited by or be dependent upon any particular theory, it is theorized that the difference between falafel made from fresh dough and falafel made from frozen dough is due to “micro-bubbles” that form during the blending or mixing process. These micro-bubbles cause falafel that is freshly made from a dough or mixture that is freshly blended from scratch to have an airy, fluffy, and light texture. It may be that these micro-bubbles are reduced in number if the dough is not fried immediately, and the micro-bubbles may collapse and be totally lost when the dough is frozen. The embodiments herein allow for the benefits of using frozen ingredients while still providing the benefits of the micro-bubbles that may be present in the dough after mixing.

Some embodiments herein use two frozen preparations or components. The first preparation or component is a dough including the blended beans, and the second preparation or component includes one or more blended flavoring ingredients as called for by the recipe, such as, for example, onions, garlic, and green leaves or herbs. The two preparations or components are frozen separately. After defrosting, the two preparations are blended, for example, in a blender or a food processor. The blending or mixing process may reestablish the micro-bubbles in the dough and makes the dough ready for frying.

The first component or dough typically includes at least one or more dry ingredients and water. The water may be provided as part of another wet or liquid ingredient. For making falafel, the dough typically includes chickpeas (also known as garbanzo beans) and water. Falafel dough may be made from dry chickpeas that are soaked in water usually for twelve to twenty-four hours. The soaked chickpeas are then drained and blended to form a dough. The soaked and drained chickpeas will have sufficient water content for blending into a dough. Falafel dough may also be made from canned chickpeas. The canned chickpeas are drained and blended to form a dough. The canned chickpeas are wet and will have sufficient water content for blending into a dough. Falafel dough may also be made from dry chickpea flour. Water or other liquid or wet ingredients need to be added to the chickpea flour and the mixture may then be blended to form a dough. In some recipes, the falafel dough may also include additional ingredients such as fava beans, wheat flour, bread crumbs or combinations of these.

The second component, also referred to as the flavoring ingredients, includes one or more ingredients selected from onion, parsley, cilantro, garlic, shallot, cumin, coriander, black pepper, cayenne pepper, paprika, cardamom, lemon or lime zest, lemon or lime juice, and dried lemon or lime (whole or flakes) depending upon the particular recipe being used. It should also be noted that some of the flavoring ingredients may be included in the first component or dough and that some of the additional ingredients listed for the dough may be included in the second component. Some recipes may also call for baking soda, which is preferably added after the two components are thawed and before or during the mixing or blending of the two components. The lists of ingredients listed for the first and second components are not exhaustive and are not intended to be limiting. The examples herein below show typical recipes for falafel.

### EXAMPLE 1

a) 1 lb. dry chickpeas/garbanzo beans, these must be soaked in water and drained prior to further processing;
b) 1 small onion, coarsely chopped;
c) ¼ cup chopped fresh parsley;
d) 3 to 5 cloves garlic;
e) 1 and ½ tablespoons of flour or chickpea flour;

f) 1 and ¾ teaspoons salt;
g) 2 teaspoons cumin;
h) 1 teaspoon ground coriander;
i) ¼ teaspoon black pepper;
j) ¼ teaspoon cayenne pepper;
k) Pinch of ground cardamom; and
l) Vegetable oil for frying—grapeseed, sunflower, avocado, canola, and peanut oils are examples of suitable oils for frying the cooking portions.

### EXAMPLE 2

a) 1 (15-oz.) can chickpeas, drained;
b) 4 cloves garlic, roughly chopped;
c) 1 shallot, roughly chopped;
d) 2 tablespoons freshly chopped parsley;
e) 1 teaspoon ground cumin;
f) 1 teaspoon ground coriander;
g) 3 tablespoons all-purpose flour;
h) Salt;
i) Freshly ground black pepper; and
j) Vegetable oil, for frying.

### EXAMPLE 3

a) 2 cups dried chickpeas, these must be soaked in water and drained prior to further processing;
b) 1 teaspoon whole cumin seed;
c) 1 teaspoon whole coriander seed;
d) 3 cloves garlic, minced;
e) 1 small yellow onion, peeled and coarsely chopped;
f) 1 cup chopped fresh cilantro leaves;
g) 1 cup chopped fresh parsley leaves;
h) Zest of 1 lemon;
i) ¼ teaspoon cayenne;
j) 1 and ½ teaspoons salt;
k) ½ teaspoon ground black pepper; and
l) Vegetable oil for frying.

The term “dough” as used herein means any mass of material with sufficient cohesion such that the mass of material can be shaped into cooking portions such as, for example, patties or balls. The term “blending” as used herein means any type of blending, mixing, grinding, and kneading performed using machines, such as mixers, blenders, and food processors for example, or by hand. Blending may also involve comminuting of ingredients that are present in relatively large pieces. The term “mechanical agitation” includes blending as defined herein. “Thawing” and “defrosting” are used interchangeably herein. The term “legume” as used herein refers to the members of the pea family and includes beans, peas, chickpeas, and lentils. The term “onion family” as used herein includes chives; onions including white onions, red onions, and yellow onions; green onions (also are known as scallions); leeks; shallots; and garlic. The terms “isolated” or “in isolation” as used herein refer to two or more components that are prevented from coming into contact with one another.

Referring to FIGS. 1 through 3 and 8, some embodiment herein are directed to methods for preparing a food item from frozen dough. In one embodiment, the method comprises thawing (104) the frozen dough to provide a thawed dough; mechanically agitating (106) the thawed dough; forming (108) at least one cooking portion (e.g. balls 100 or patties 102) of a precursor for the food item, the precursor including at least an amount of the thawed dough; and cooking (110) the cooking portion of the precursor to obtain the food item. The precursor of the food item is the dough after the step of mechanically agitating (106) has been completed and that is ready to be cooked to obtain the food item, which in some examples herein is falafel. The frozen dough 112 may be the first component of a frozen food product 114 for preparing the food item.

In some examples, the method further comprises providing (116) a second component 118 that includes at least one additional ingredient. The step of providing (116) a second component is followed by mixing (120) the at least one additional ingredient with the thawed dough such that the at least one additional ingredient is evenly distributed throughout the thawed dough as a result of the step of mechanically agitating (106) the thawed dough and the precursor comprises at least the thawed dough and the at least one additional ingredient. The second component is the flavoring ingredient or ingredients in the illustrative examples herein. In some embodiments herein, the second component or the at least one additional ingredient may initially be frozen, and the method includes the further step of thawing the second component or the at least one additional ingredient before mixing the second component or the at least one additional ingredient with the thawed dough.

In some embodiments herein, the step of mechanically agitating (106) the thawed dough is carried on at least long enough to evenly distribute the at least one additional ingredient throughout the thawed dough.

In some embodiments herein, the frozen dough 112 comprises at least one legume. In some embodiments herein, the frozen dough 112 comprises at least one legume, and the second component 118 comprises one or more ingredients selected from the group consisting of onion, garlic, and at least one herb. In some examples, the at least one legume is chickpeas, and the at least one herb comprises one or more herbs selected from the group consisting of parsley and cilantro. In some examples, the at least one legume is chickpeas, and the at least one herb comprises parsley.

In some examples, the frozen dough 112 comprises at least one legume, and the second component 118 comprises at least one member of the onion family. In some examples, the at least one member of the onion family is selected from the group comprising onion, shallot, and garlic. In some examples, the at least one legume is chickpeas, and the at least one member of the onion family is onion.

In some examples, the second component 118 comprises onion, garlic, and at least one herb. In some examples, the frozen dough 112 comprises at least one legume, and the second component 118 comprises onion, garlic, and at least one herb. In some examples, the at least one legume is chickpeas, and the second component 118 comprises onion, garlic, and at least one herb. In some examples, the at least one legume is chickpeas, and the second component 118 comprises onion, garlic, and at least one herb selected from the group consisting of parsley and cilantro.

Referring to FIGS. 1, 2, and 4 through 8, some embodiment herein are directed to methods for preparing a frozen product for preparation of a food item. In one example the food item may be falafel. In some embodiments herein, the method for preparing the frozen product comprises:

a) preparing (122) a dough;

b) preparing (124) at least one additional ingredient;

c) freezing (126) the dough to produce a frozen dough 112;

d) freezing (128) the at least one additional ingredient to produce at least one frozen additional ingredient; and

e) packaging (130) the frozen dough 112 and the at least one frozen additional ingredient, which forms at least a part of the second component of the frozen product 114, such that the at least one frozen additional ingredient and the frozen dough remain isolated from each other while frozen prior to the initiation of steps to prepare the food item from the frozen dough and the at least one frozen additional ingredient. The frozen dough 112 constitutes the first component of the frozen product 114.

In the illustrative embodiments herein, the frozen dough 112 and the at least one frozen additional ingredient are packaged together as parts of the same overall packaging 132 while being maintained in isolation from each other.

In some embodiments herein, the step (122) of preparing the dough comprises a sequence of steps selected from a group of sequences of steps consisting of a first sequence of steps (134), a second sequence of steps (136), and a third sequence of steps (138).

The first sequence of steps (134) comprises:

a) providing (140) a quantity of at least one dry legume;

b) soaking (142) the dry legume to provide wet legume; and

c) blending (144) at least the wet legume to provide the dough.

The second sequence of steps (136) comprises:

a) providing (146) a quantity of at least one wet legume; and

b) blending (148) at least the wet legume to provide the dough.

The third sequence of steps (138) comprises:

a) providing (150) a quantity of at least one legume flour;

b) hydrating (152) the legume flour to provide a hydrated legume flour; and

c) blending (154) at least the hydrated legume flour to provide the dough.

In some embodiments herein, the legume comprises one or more of the group of legumes consisting of chickpea and fava bean. In some examples, the at least one additional ingredient comprises one or more ingredients selected from the group consisting of onion, garlic, and at least one herb. In some examples, the at least one additional ingredient comprises onion, garlic, and at least one herb.

Some embodiment herein are directed to a product 114 comprising a dough comprising at least one legume; at least one additional ingredient comprising one or more ingredients selected from the group consisting of onion, garlic, and at least one herb; and packaging containing the dough and the at least one additional ingredient, the packaging being adapted such that the at least one additional ingredient and the dough remain isolated from each other prior to the initiation of steps to prepare the food item from the dough and the at least one additional ingredient. The product is adapted to be frozen to extend its shelf life and to preserve it during storage and transportation.

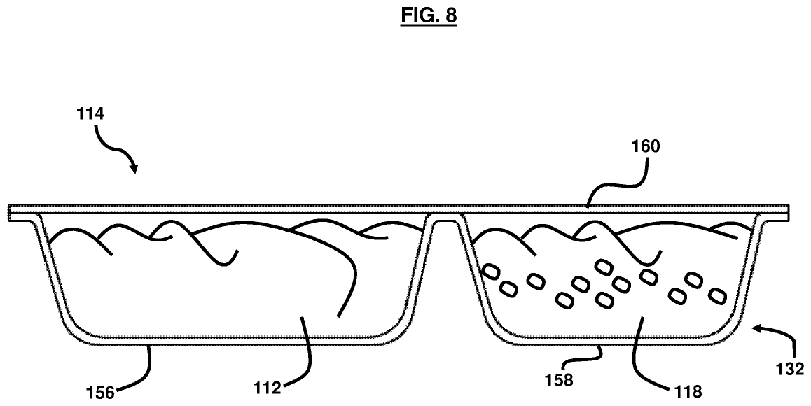

Also, the product packaging 132 is adapted for being frozen with its contents, such that the dough may be kept as a frozen dough 112, and the at least one additional ingredient may be kept as at least one frozen additional ingredient. Furthermore, the packaging 132 is adapted to keep the frozen dough and the at least one frozen additional ingredient isolated from each other at least while the packaging and its contents are being kept frozen. The frozen dough 112 constitutes the first component of the product 114, while the at least one frozen additional ingredient forms at least a part of the second component 118 of the product 114. In the illustrative embodiment of FIG. 8, the packaging 132 has a first compartment 156 for the dough 112 and a second compartment 158 for the second component 118. In the illustrative embodiment of FIG. 8, the packaging 132 is in the form of a compartmentalized plastic tray covered by an impermeable membrane 160.

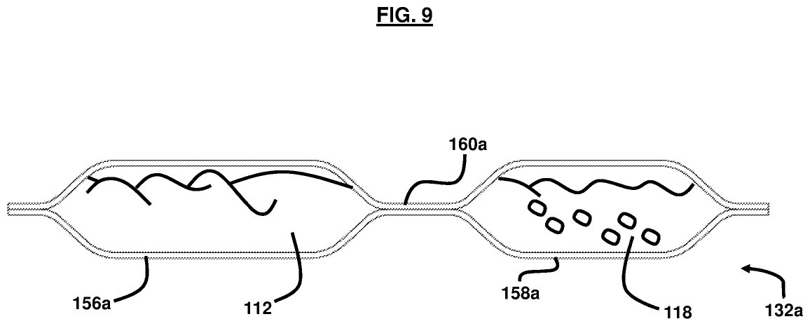

Referring to FIG. 9, an alternative product packaging 132a can be seen. The product packaging 132a is adapted for being frozen with its contents. Furthermore, the packaging 132a is adapted to keep the frozen dough and the at least one frozen additional ingredient isolated from each other at least while the packaging and its contents are being kept frozen. In the illustrative embodiment of FIG. 9, the packaging 132a has a first compartment 156a for the dough 112 and a second compartment 158a for the second component 118. In the illustrative embodiment of FIG. 9, the packaging 132a is in the form of a flexible sleeve 160a that is sealed at its ends and at a location between its ends to form the compartments 156a and 158a.

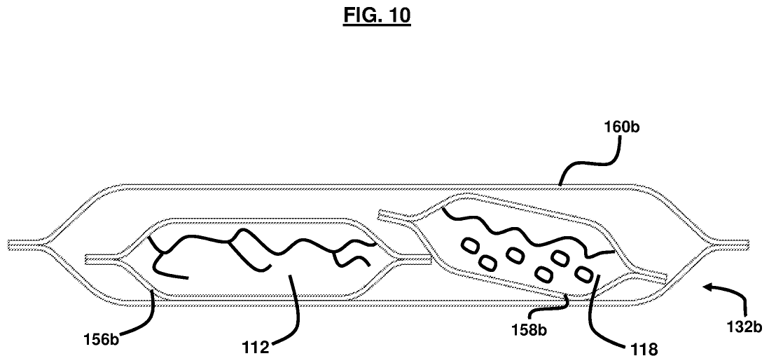

Referring to FIG. 10, an alternative product packaging 132b can be seen. The product packaging 132b is adapted for being frozen with its contents. Furthermore, the packaging 132b is adapted to keep the frozen dough and the at least one frozen additional ingredient isolated from each other at least while the packaging and its contents are being kept frozen. In the illustrative embodiment of FIG. 10, the packaging 132b is in the form of an outer bag 160b that contains a first bag or packet 156b for the dough 112 and a second bag or packet 158b for the second component 118.

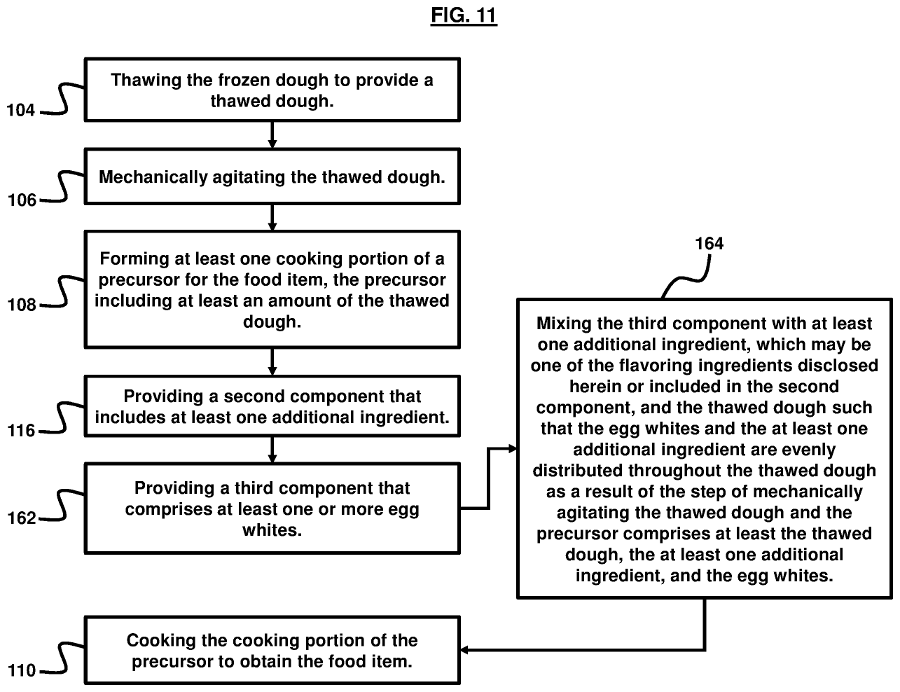

Referring to FIGS. 11 through 13, some of the embodiments disclosed herein may be based on recipes for a food item that include one or more egg whites, in other words the whites of one or more eggs. In particular, some of the embodiments disclosed herein may be based on recipes for falafel that include one or more egg whites. The egg whites may be prepared by breaking open one or more eggs and then separating the egg white from the egg yolk. The egg whites may then be mixed or blended into the dough before the dough is frozen. In some embodiments, the egg whites may be whipped before being mixed into the dough.

In some embodiments, the egg whites may be frozen separately, and kept separate while stored, from the first component including the dough and the second component including one or more flavoring ingredients. In some such embodiments, the egg whites may be whipped before being frozen. Some embodiments disclosed herein include recipes for falafel comprising ground or blended wetted legume, which may comprise chick peas, fava beans, and mixtures thereof; at least one flavoring ingredient selected from the group consisting of the onion family and herbs; and one or more egg whites, which may be whipped before being blended with the other ingredients or components. “Herbs” as used herein encompasses herbs and greens.

Accordingly, in some embodiments herein, the methods further comprise providing (162) a third component that comprises at least one or more egg whites; and mixing (164) the third component with at least one additional ingredient, which may be one of the flavoring ingredients disclosed herein or included in the second component, and the thawed dough such that the egg whites and the at least one additional ingredient are evenly distributed throughout the thawed dough as a result of the step of mechanically agitating the thawed dough and the precursor comprises at least the thawed dough, the at least one additional ingredient, and the egg whites.

In some embodiments herein, the frozen product comprises a first component 112, a second component 118, and a third component 166. The first component comprises the dough, the second component comprises at least one additional ingredient, e.g. a flavoring ingredient, and the third component comprises at least one or more egg whites. In some embodiments herein, the methods further comprise preparing (168) the egg whites;

freezing (170) the egg whites; and packaging (172) the first component 112, the second component 118, and the third component 166 such that the first component, the second component, and the third component remain isolated from one another while frozen prior to the initiation of steps to prepare the food item from the first component, the second component, and the third component.

In some embodiments herein, the frozen product comprises a first component 112, a second component 118, and a third component 166, the first component comprises the dough, the second component comprises at least one additional ingredient, e.g. one or more of the flavoring ingredients disclosed herein, and the third component comprises at least one or more egg whites. The packaging is adapted for being frozen with its contents, and the packaging is adapted to keep the first component, the second component, and the third component isolated from one another at least while the packaging and its contents are being kept frozen. Without intending to be limiting, any of the styles or types packaging disclosed herein may be adapted for use with three or more components by adding a corresponding number of compartments or packets as needed.

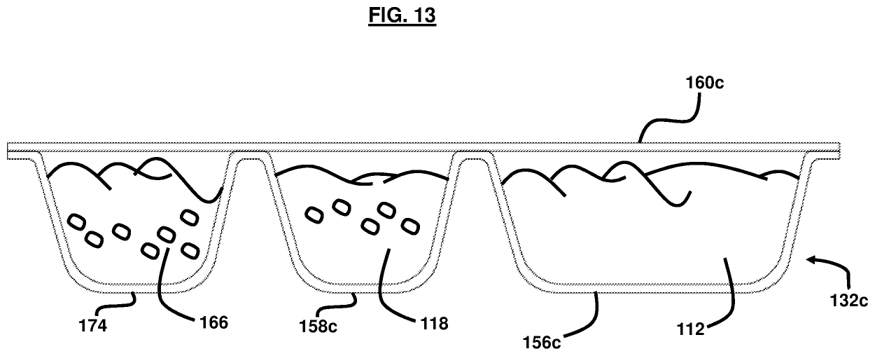

In one example, the product packaging 132c is adapted for being frozen with its contents. Furthermore, the packaging 132c is adapted to keep the frozen dough 112, the at least one frozen additional ingredient 118, and the third component 166 isolated from one another at least while the packaging and its contents are being kept frozen. In the illustrative embodiment of FIG. 13, the packaging 132c has a first compartment 156c for the dough 112, a second compartment 158c for the second component 118, and a third compartment 174 for the third component 166. In the illustrative embodiment of FIG. 13, the packaging 132c is in the form of a compartmentalized plastic tray covered by an impermeable membrane 160c.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. A method for preparing a food item from frozen dough, the method comprising:
thawing the frozen dough to provide a thawed dough;
mechanically agitating the thawed dough;
forming at least one cooking portion of a precursor for the food item, the precursor including at least an amount of the thawed dough; and
cooking the cooking portion of the precursor to obtain the food item.

2. The method of claim 1, wherein the frozen dough is a first component of a frozen food product for preparing the food item, the method further comprising:
providing a second component that includes at least one additional ingredient; and
mixing the at least one additional ingredient with the thawed dough such that the at least one additional ingredient is evenly distributed throughout the thawed dough as a result of the step of mechanically agitating the thawed dough and the precursor comprises at least the thawed dough and the at least one additional ingredient.

3. The method of claim 2, wherein the step of mechanically agitating the thawed dough is carried on at least long enough to evenly distribute the at least one additional ingredient throughout the thawed dough.

4. The method of claim 2, wherein the frozen dough comprises at least one legume, and wherein the second component comprises one or more ingredients selected from the group consisting of onion, garlic, and at least one herb.

5. The method of claim 4, wherein the at least one legume is chickpeas, and wherein the at least one herb comprises one or more herbs selected from the group consisting of parsley and cilantro.

6. The method of claim 2, further comprising:
providing a third component that comprises at least one or more egg whites; and
mixing the third component with the at least one additional ingredient and the thawed dough such that the egg whites and the at least one additional ingredient are evenly distributed throughout the thawed dough as a result of the step of mechanically agitating the thawed dough and the precursor comprises at least the thawed dough, the at least one additional ingredient, and the egg whites.

7. The method of claim 2, wherein the frozen dough comprises at least one legume, and wherein the second component comprises at least one member of the onion family.

8. The method of claim 7, wherein the at least one legume is chickpeas, and wherein the at least one member of the onion family is onion.

9. The method of claim 7, wherein the at least one member of the onion family is selected from the group comprising onion, shallot, and garlic.

10. The method of claim 2, wherein the second component comprises onion, garlic, and at least one herb.

11. The method of claim 10, wherein the at least one herb comprises one or more herbs selected from the group consisting of parsley and cilantro.

12. A method for preparing a frozen product for preparation of a food item, the method comprising:
preparing a dough;
preparing at least one additional ingredient;
freezing the dough to produce a frozen dough;
freezing the at least one additional ingredient to produce at least one frozen additional ingredient; and
packaging the frozen dough and the at least one frozen additional ingredient such that the at least one frozen additional ingredient and the frozen dough remain isolated from each other while frozen prior to the initiation of steps to prepare the food item from the frozen dough and the at least one frozen additional ingredient.

13. The method of claim 12, wherein the frozen dough and the at least one frozen additional ingredient are packaged together as parts of the same overall packaging while being maintained in isolation from each other.

14. The method of claim 12, wherein the step of preparing the dough comprises a sequence of steps selected from a group of sequences of steps consisting of a first sequence of steps, a second sequence of steps, and a third sequence of steps,
wherein the first sequence of steps comprises:
providing a quantity of at least one dry legume;
soaking the dry legume to provide wet legume; and
blending at least the wet legume to provide the dough;
wherein the second sequence of steps comprises:
providing a quantity of at least one wet legume; and
blending at least the wet legume to provide the dough; and
wherein the third sequence of steps comprises:
providing a quantity of at least one legume flour;
hydrating the legume flour to provide a hydrated legume flour; and
blending at least the hydrated legume flour to provide the dough.

15. The method of claim 14, wherein the legume comprises one or more of the group of legumes consisting of chickpea and fava bean.

16. The method of claim 15, wherein the at least one additional ingredient comprises one or more ingredients selected from the group consisting of onion, garlic, and at least one herb.

17. The method of claim 16, wherein the frozen product comprises a first component, a second component, and a third component, wherein the first component comprises the dough, the second component comprises the at least one additional ingredient, and the third component comprises at least one or more egg whites, the method further comprising:
preparing the egg whites;
freezing the egg whites; and
packaging the first component, the second component, and the third component such that the first component, the second component, and the third component remain isolated from one another while frozen prior to the initiation of steps to prepare the food item from the first component, the second component, and the third component.

18. A product comprising:
a dough comprising at least one legume;
at least one additional ingredient comprising one or more ingredients selected from the group consisting of onion, garlic, and at least one herb; and
packaging containing the dough and the at least one additional ingredient, the packaging being adapted such that the at least one additional ingredient and the dough remain isolated from each other prior to the initiation of steps to prepare the food item from the dough and the at least one additional ingredient.

19. The product of claim 18, wherein the packaging is adapted for being frozen with its contents, wherein the dough is a frozen dough, wherein the at least one additional ingredient is at least one frozen additional ingredient, and wherein the packaging is adapted to keep the frozen dough and the at least one frozen additional ingredient isolated from each other at least while the packaging and its contents are being kept frozen.

20. The product of claim 18, wherein the frozen product comprises a first component, a second component, and a third component, wherein the first component comprises the dough, the second component comprises the at least one additional ingredient, and the third component comprises at least one or more egg whites, wherein the packaging is adapted for being frozen with its contents, and wherein the packaging is adapted to keep the first component, the second component, and the third component isolated from one another at least while the packaging and its contents are being kept frozen.
